(19) United States
(12) Patent Application Publication
(10) Pub. No.: US 2013/0314714 A1
(43) Pub. Date: Nov. 28, 2013

(54) APPARATUS FOR ACQUIRING INFORMATION OF OBJECT, AND PROGRAM

(71) Applicant: Canon Kabushiki Kaisha, Tokyo (JP)

(72) Inventor: Kentaro Nagai, Yokohama-shi (JP)

(73) Assignee: CANON KABUSHIKI KAISHA, Tokyo (JP)

(21) Appl. No.: 13/902,694

(22) Filed: May 24, 2013

(30) Foreign Application Priority Data
May 28, 2012 (JP) 2012-121245
May 2, 2013 (JP) 2013-097079

(51) Int. Cl. G01B 9/02

(52) U.S. Cl. CPC G01B 9/02
USPC 356/451; 356/450

(57) ABSTRACT

An apparatus for acquiring information of an object includes an interferometer and an arithmetic unit. The interferometer includes an optical device that forms an interference pattern with light from a light source, and a detector that detects the interference pattern. The arithmetic unit acquires information related to a phase of an object using a first detection result and a second detection result detected by the detector. The arithmetic unit acquires the information related to the phase of the object using information on distribution of changes of the interferometer acquired from the first detection result and the second detection result.

### BACKGROUND OF THE INVENTION

1. Field of the Invention

The present invention relates to an apparatus for acquiring information of an object, a method of acquiring information of an object, and a program, and particularly relates to an apparatus for acquiring information of an object using interference of electromagnetic waves, and a method of acquiring information of an object and a program used in the apparatus for acquiring information of an object.

2. Description of the Related Art

In the past, as a means to measure a substance precisely, a measuring method using interference of electromagnetic waves, such as visible light and high energy radiation, has been used extensively. This technique is generally referred to as the interference method. Typically, the interference method measures wavefront change of electromagnetic waves caused by an object by causing the electromagnetic waves having aligned wavefronts to enter the object and to interfere to form an interference pattern (interference fringe), and detecting and analyzing the interference pattern. In the specification, a change in the wavefront of electromagnetic waves caused by light interacting with an object is regarded as a type of information on the object. A measurement device using interference of electromagnetic waves is called an interferometer. There are namely two types of interferometers; differential (also called lateral shift) interferometers and other interferometers (herein referred to as “non-differential interferometers”). A differentiated phase change of the wavefronts of the electromagnetic waves (differential phase) can be obtained from the differential interferometer, and a phase change of the wavefronts of the electromagnetic waves can be obtained from the non-differential interferometer, respectively. Note that, when the differential phase obtained from the differential interferometer is integrated, a phase can be obtained. In the present specification, the differential phase and the phase are collectively referred to as information related to a phase or phase information.

There are basically two major phase recovery methods that are techniques of recovering the phase information from an interference pattern. The first one is the Fourier transform method. In this technique, the interference pattern is subjected to Fourier transform, and the phase information is acquired from a carrier frequency spectrum of the interference pattern and spectrum data at a periphery of the carrier frequency spectrum.

The second one is a phase shift method. In this technique, typically, a phase is shifted by moving an optical device by a width at a fraction of a cycle of the interference pattern, the interference pattern is changed and is detected intermittently, and a phase is acquired from a change in each detection result.

A technique other than the above or a technique mixed with the phase shift method may be employed.

In a case where the phase recovery is performed using the phase shift method, it is required to shift a phase by a predetermined amount. However, it is difficult to control a change of phase in each detection, and an error of a phase shift amount leads to an error of the phase information obtained by the phase recovery.

As a method of correcting such an error of the phase information, Japanese Patent No. 4583619 (corresponding U.S. Pat. No. 6,532,073) discloses a method in which a phase shift amount and an error thereof, which are caused when the phase shift method is used, are acquired, and the phase information is acquired, in which the error has been corrected. In the method disclosed in Japanese Patent No. 4583619 (corresponding U.S. Pat. No. 6,532,073), interference patterns before and after the phase shift are respectively subjected to Fourier transform, and peak values of carrier frequencies of the interference patterns are compared. In this manner, an error of an amount of shift and relative inclination of a reference surface and a surface to be examined are acquired. If the acquired values are used for correction, the phase information can be obtained, in which the error of an amount of shift and the relative inclination of a reference surface and a surface to be examined have been corrected.

However, when the phase recovery is performed using the phase shift method, not only the error of the phase shift amount, but also minute distortion or deformation of the optical device itself caused by a change in temperature or other environmental conditions, unevenness of radiation of light emitted from a light source, and the like may be caused. If such things happen, a partial change in the interference pattern (hereinafter, referred to as a partial change) is caused, which may affect the phase information acquired by the phase recovery.

In a case where the phase recovery is performed using the Fourier transform method, it is not necessary to shift the phase and detect the interference pattern several times. However, a drift of the optical device may be caused, or a partial change in the interference pattern like the above may be caused, between the time of detecting reference data without arranging an object and the time of detecting measurement data of the object while the object is arranged. This may affect the phase information obtained by the phase recovery.

Therefore, an objective of the present invention is to provide an apparatus for acquiring information of an object, a method of acquiring information of an object, and a program capable of acquiring information on distribution of changes due to a cause other than the object from among changes of interference patterns and capable of acquiring phase information in which an influence of the distribution of changes is reduced.

### SUMMARY OF THE INVENTION

An apparatus for acquiring information of an object including:

an interferometer including an optical device configured to form an interference pattern by light entering from a light source, and a detector configured to detect the interference pattern; and

an arithmetic unit configured to acquire information related to a phase of an object using a first detection result and a second detection result detected by the detector,

wherein the arithmetic unit acquires the information related to the phase of the object using information on distribution of changes of the interferometer acquired from the first detection result and the second detection result.

Further features of the present invention will become apparent from the following description of exemplary embodiments (with reference to the attached drawings).

### BRIEF DESCRIPTION OF THE DRAWINGS

FIG. 1 is a schematic diagram of an X-ray Talbot interferometer according to an embodiment;

FIGS. 2A and 2B are enlarged views of examples of reference data according to the embodiment;

FIGS. 3A and 3B are examples of object data according to the embodiment;

FIGS. 4A to 4D are diagrams illustrating an object to be used in a reference example and in an exemplary embodiment, and theoretical phase information thereof;

FIG. 5 is object data used in the reference example and in the exemplary embodiment;

FIGS. 6A to 6E are diagrams illustrating simulation results according to Exemplary embodiment 1;

FIG. 7 is a flowchart of a method of acquiring phase information according to Exemplary embodiment 2;

FIGS. 8A to 8E are diagrams illustrating simulation results by Exemplary embodiment 2;

FIGS. 9A to 9E are diagrams illustrating simulation results by Exemplary embodiment 3;

FIGS. 10A to 10C are diagrams illustrating simulation results by Exemplary embodiment 4;

FIGS. 11A to 11D are diagrams illustrating simulation results by Reference examples 1 and 2; and

FIG. 12 is a diagram illustrating a simulation result by Reference example 3.

### DESCRIPTION OF THE EMBODIMENTS

Hereinafter, embodiments of the present invention will be described with reference to the drawings.

An apparatus for acquiring information of an object of the present embodiment includes an interferometer and an arithmetic unit. The interferometer includes an optical device that forms an interference pattern by an electromagnetic wave entering from an electromagnetic wave source and a detector that detects the interference pattern, and the arithmetic unit acquires information related to a phase of an object using a detection result detected by the detector.

Any interferometer may be used in the embodiment as long as it can form an interference pattern by interference of electromagnetic waves and can detect the interference pattern. However, hereinafter, a case of using an X-ray Talbot interferometer that is a differential interferometer using an X-ray will be described as an example. Note that, in the embodiment, an X-ray refers to an electromagnetic wave of 2 to 200 Kilo-electronvolts (KeV) inclusive.

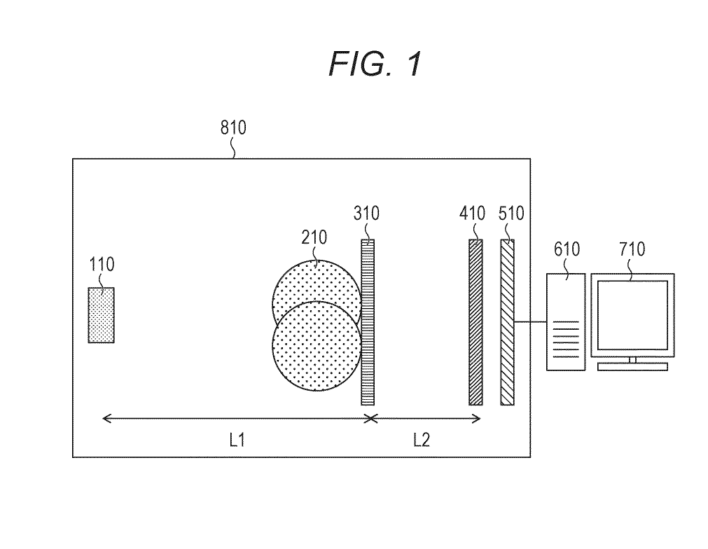

FIG. 1 is a schematic diagram illustrating a configuration of an apparatus for acquiring information of an object according to the present embodiment. An apparatus for acquiring information of an object illustrated in FIG. 1 includes an X-ray Talbot interferometer 810 and an arithmetic unit 610. The X-ray Talbot interferometer 810 includes an X-ray source 110, a diffraction grating 310, a shield grating 410, and a detector 510. The X-ray source (light source) 110 generates X-ray radiation (an X-ray); the diffraction grating 310 diffracts the X-ray from the X-ray source 110 and forms an interference pattern (not illustrated). That is, the diffraction grating 310 functions as an optical device that forms an interference pattern. The detector 510 detects an X-ray after the X-ray travels through the shield grating 410. The shield grating 410 shields a part of the X-ray transmitted through the diffraction grating 310. The arithmetic unit 610 is connected to the detector 510, and acquires phase information on an object based on a detection result detected by the detector 510. In a measurement operation, an object 210 is disposed in the X-ray path between the X-ray source 110 and the detector 510. Specifically, the object 210 may be disposed either between X-ray source 110 and the diffraction grating 310 (as illustrated), or elsewhere in the X-ray path). Further, the apparatus for acquiring information of the object 210 is connected to an image display apparatus 710 that displays an image based on the phase information on the object acquired by the arithmetic unit 610. Therefore, the X-ray Talbot interferometer 810 and arithmetic unit 610 connected to the image display apparatus 710 form an image pickup system.

In operation, an X-ray from the X-ray source 110 is transmitted through the object 210 whereby the X-ray is subjected to phase modulation by the object. The phase-modulated X-ray is then diffracted by the diffraction grating 310. The diffraction grating 310 forms an interference pattern in which a bright section and a dark section are arrayed in an array direction with a predetermined distance called a Talbot distance. When this interference pattern is detected by the detector 510, and phase recovery is performed by the arithmetic unit 610, information related to a phase change caused by the object (phase of the object) can be obtained.

However, in the case of the Talbot interferometer using an X-ray, a cycle of the interference pattern formed by the diffraction grating 310 is typically about from several μm to more than ten μm. Meanwhile, a typical size of the detection device of the detector of an X-ray is several tens of μm or more. Therefore, the shield grating 410, in which a shield unit and a transmission unit are arrayed with a cycle slightly different from the cycle of the interference pattern, is arranged at a position where the interference pattern is formed. When the shield grating 410 is used in this way, a moiré is formed by the interference pattern and the shield grating, and the cycle of the interference pattern can be enlarged to several tens of microns or more. Accordingly, the interference pattern can be detected even if the detector 510 having detection elements with a pitch of about several tens of μm is used. In this way, in the present specification, indirect detection of an interference pattern using a shield grating by forming a moiré and the like is also referred to as detection of an interference pattern. Note that, even in a case of performing an X-ray Talbot, the interference pattern may be directly detected by enlarging the cycle of the interference pattern by enlarging the distance between the diffraction grating and the detector, or by using a detector having detection small elements with a small pitch.

Any detector may be used as long as it can detect an X-ray and, for example, an indirect-converting type flat panel detector or a direct-converting type flat panel detector may be used. However, the size of the detection device is selected so that a moiré can be detected (in a case of direct direction, an interference pattern can be detected).

Note that the apparatus for acquiring information of an object illustrated in FIG. 1 has the object arranged between the X-ray source and the diffraction grating. However, the object may be arranged between the diffraction grating and the phase grating (in a case of not using the phase grating, between the diffraction grating and the detector).

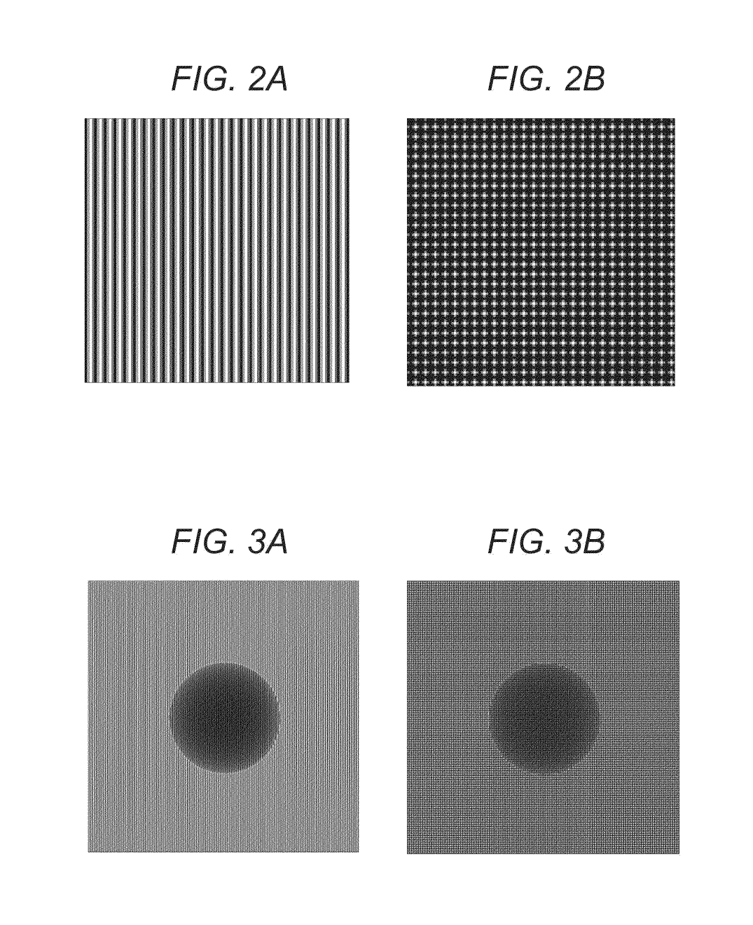

Enlarged views of examples of the moiré detected in the embodiment are illustrated in FIGS. 2A and 2B. However, the two moirés illustrated in FIGS. 2A and 2B are examples formed on the detector when an object 210 is not arranged between the X-ray source and the phase grating, and are examples of reference data. FIG. 2A illustrates an example of a one-dimensional moiré in a case where a one-dimensional pattern is used for the diffraction grating 310 and for the shield grating 410. Also, FIG. 2B illustrates an example of a two-dimensional moiré in a case where a two-dimensional pattern is used for the diffraction grating 310 and for the shield grating 410.

When the object is arranged between the X-ray source and the diffraction grating, a differential amount of a wavefront change of an X-ray by the object is superimposed on the moirés illustrated in FIGS. 2A and 2B. Moirés formed on the detector at the time are respectively illustrated in FIGS. 3A and 3B. The X-ray is diffracted and absorbed by the object, and the shapes of the moirés are deformed according to the shape of the object and constitution element. Since the Talbot interferometer is a differential interferometer as described above, the differential amount of the wavefront change of the X-ray by the object is superimposed on the moirés. When an interferometer that is not a differential interferometer is used in place of the Talbot interferometer, a change of the wavefront of the X-ray by the object is superimposed on a moiré (or on an interference pattern).

The arithmetic unit 610 is connected to the detector 510 and acquires phase information on the object using at least two detection results. A method of acquiring the phase information on the object by the arithmetic unit in the present embodiment will be described.

An outline of the method of acquiring phase information is as follows:

1. Acquire provisional phase information of the object (hereinafter, may sometimes be referred to as provisional information) by performing phase recovery using a first detection result and a second detection result.

2. Acquire information on distribution of changes caused by the interferometer including a light source (hereinafter, may sometimes be referred to as changes of the interferometer) from differences between the first detection result and the second detection result.

3. Acquire (corrected) phase information on the object by correcting the provisional information using the information on distribution of changes of the interferometer.

With the above-described method, phase information on an object in which an influence due to changes of an interferometer has been reduced can be acquired. Here, the changes of the interferometer refers to changes of the interference pattern due to a change of a position of the optical device, distortion, expansion, and contraction of the optical device, and the like, and refers to changes caused by a cause other than the object among the changes of the interference pattern.

Hereinafter, processes will be described.

A phase shift method or a Fourier transform method may be used for the phase recovery of 1. Here, a case will be described, in which provisional phase information is acquired by a Fourier transform method using reference data as the first detection result and object data as the second detection result.

First, a typical Fourier transform method will be briefly described. In a Fourier transform method, a detected moiré is subjected to Fourier transform, and a carrier frequency spectrum that is a frequency deriving from a cycle of the moiré is obtained. Next, a spectrum within a certain area is extracted from the carrier frequency spectrum, and the extracted spectrum is moved into a neutral position in a wave number space and is subjected to inverse Fourier transform. Accordingly, a phase of a wavefront of an electromagnetic wave can be recovered. Then, unwrap (phase connection) and the like are performed as needed to rectify the phase. In a case where a moiré is not formed, a detected interference pattern is subjected to a Fourier transform method. The processing itself of the Fourier transform method is similar when an interferometer other than a Talbot interferometer is used.

In the case where the Fourier transform method is performed using the reference data as the first detection result and the object data as the second detection result, differences between the first detection result and the second detection result are obtained and information on relative intensity distribution is acquired. When this information on relative intensity distribution is subjected to the above-described Fourier transform method, information on a provisional differential phase image can be acquired as provisional phase information on the object. Note that, the first detection result and the second detection result may be respectively subjected to the Fourier transform method, and provisional phase information obtained from the first detection result may be subtracted from provisional phase information obtained from the second detection result.

Next, information on distribution of changes of the interferometer is acquired. The distribution of changes of the interferometer refers to distribution of an amount of change other than an amount of change of a phase caused by the object, among amounts of change (differences) when the first detection result and the second detection result are compared. That is, in the present embodiment, the differences between the first detection result and the second detection result can be considered to be classified into a difference caused by the object and a difference caused by the interferometer, and the distribution of an amount of change of a phase caused by the interferometer is referred to as the distribution of changes of the interferometer. In the present embodiment, among the differences between the first detection result and the second detection result, a low frequency component (lower component) is considered to include information on the changes of the interferometer and a high frequency component (higher component) is considered to include information on the object. That is, the distribution of the lower component among the differences between the first detection result and the second detection result is considered to be the distribution of changes of the interferometer.

Note that, when the differential interferometer is used like the present embodiment, distribution of a differential amount of the amount of change of a phase caused by the interferometer can be obtained as the distribution of changes of the interferometer. When an interferometer that is not a differential interferometer is used, distribution of an amount of change of a phase caused by the interferometer is obtained as the distribution of changes of the interferometer.

In the present embodiment, information on changes of the interferometer is obtained not only as a single value but also as distribution. Accordingly, not only the amount of change (an overall amount of change) of a relative position of the interference pattern and the shield grating, and relative inclination, but also information on a partial amount of change of the interferometer, such as partial distortion of the diffraction grating or the shield grating, can be acquired. If the information on the distribution of changes of the interferometer is used for correction in this way, phase information on the object, in which the influence due to partial changes of the interferometer has been corrected, can be acquired.

Note that, similarly, in a case where the phase recovery is performed using three or more detection results, information on distribution of changes of the interferometer of two detection results to be obtained may just be acquired in a case where an amount of change of the interferometer is obtained, which has been caused while two detection results are being detected. That is, in a case where an amount of change of the interferometer is obtained, which has been caused between when the first detection result is detected and when a third detection result is detected, information on distribution of changes of the interferometer may just be obtained using the first detection result and the third detection result.

Further, to obtain the phase information on the object by causing the arithmetic unit to perform arithmetic like the above, the arithmetic unit is caused to execute a program that performs the arithmetic like the above.

As described above, in the present embodiment, among the differences between the first detection result and the second detection result, the distribution of the lower component is used as the distribution of changes of the interferometer. Therefore, the distribution of changes of the interferometer can be acquired using the Fourier transform. The lower component that is a difference between the first detection result and the second detection result appears around a carrier frequency (in an area where the lower component is supposed to appear) when the distribution of the differences between the first detection result and the second detection result is subjected to the Fourier transform. Therefore, the information on the distribution of changes of the interferometer can be obtained by using the area around the carrier frequency in the wave number space. A specific method of acquiring the information on the distribution of changes of the interferometer will be described below as exemplary embodiments.

Next, information on the object is acquired by correcting the provisional information using the acquired distribution of changes of the interferometer.

Any correction method can be employed. For example, a difference between the provisional information and the distribution of changes of the interferometer may be obtained.

Further, in the present embodiment, the phase information on the object that has been corrected using the above-described 1 to 3 processes is acquired. However, the corrected phase information on the object can be obtained by removing the area that includes the information on the distribution of changes of the interferometer while performing the phase recovery, without acquiring the information on the distribution of changes of the interferometer and the provisional information.

In the case where the differential interferometer is used as the interferometer like the present embodiment, even if the influence on the distribution of the differential phase due to the changes of the interferometer is minute, a minute error is superimposed in acquiring the information on the distribution of a phase by integrating the information on the differential phase distribution, and as a result, large influence may occur. Therefore, when the present embodiment is applied to an apparatus for acquiring information of an object that uses a differential interferometer as an interferometer, and acquires information on phase distribution by integrating information on differential phase distribution, the effect of the present embodiment as to reduce the influence of changes of the interferometer is more likely to be obtained.

Further, especially, the wave length of an X-ray is shorter than visible light. Therefore, accuracy required for an interferometer of X-ray is higher than accuracy required for an interferometer of visible light. Therefore, the interferometer using an electromagnetic wave having a shorter wave length like an X-ray has more benefits than the interferometer of visible light, in terms of applying the present embodiment. However, the interferometer included in the apparatus for acquiring information of an object of the present embodiment may not be a differential interferometer, and may use the visible light as the electromagnetic wave, for example.

### Reference Example 1

In Reference example 1, the relative phase distribution is not obtained, and a method of performing phase recovery using reference data will be described. Note that an interferometer is the same as the two-dimensional X-ray Talbot interferometer in the above-described embodiment.

A moiré formed on a detector by the two-dimensional Talbot interferometer in the present reference example is a moiré formed in a parallel cross grating manner as illustrated in FIG. 2B.

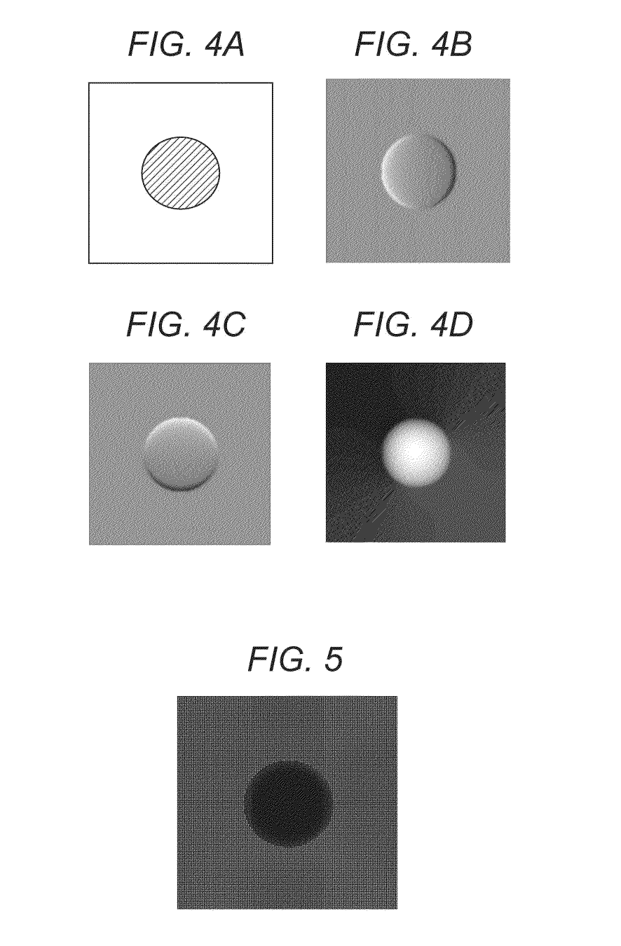

As an object, a spherical object like FIG. 4A is prepared. FIGS. 4B and 4C are diagrams illustrating respective theoretical differential phase images in the x direction and in the y direction obtained by the two-dimensional Talbot interferometer, in a case of using the object of FIG. 4A. Note that the x direction is represented in the lateral direction in the diagram, and the y direction is represented in the longitudinal direction in the diagram. Also, FIG. 4D is a theoretical phase image acquired by integrating FIGS. 4B and 4C.

FIG. 5 illustrates a moiré in which information on the object is superimposed, which is used in the present reference example as data of an object (hereinafter, it may be sometimes referred to as object data). The object data reproduces an example in which an overall change due to shifts of relative position and relative inclination of an interference pattern and a shield grating compared with the reference data, and a partial change due to distortion of a diffraction grating and the shield grating are caused.

In the present reference example, phase recovery is performed by a Fourier transform method from relative intensity distribution that is a difference between the object data (a second detection result) and the reference data (a first detection result).

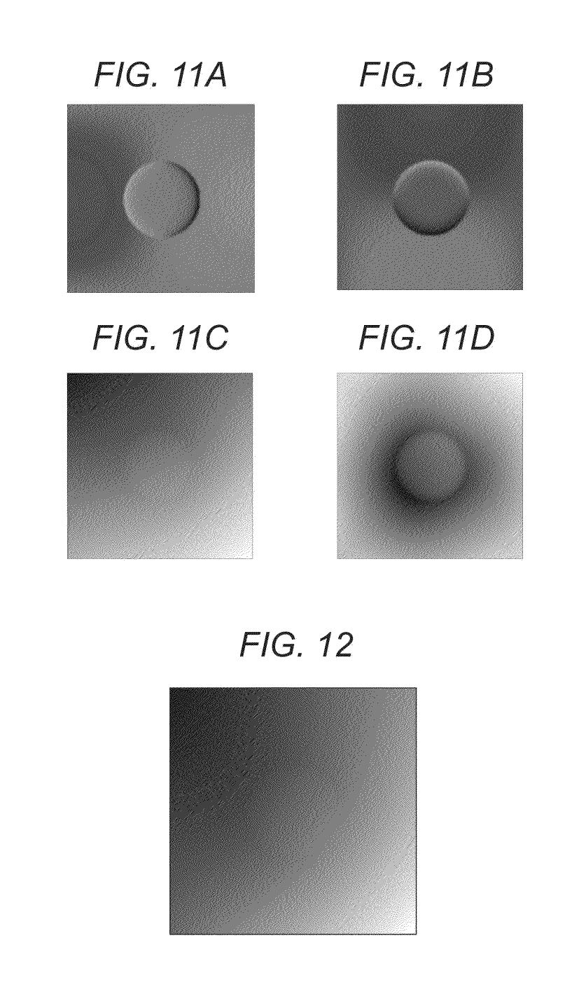

FIGS. 11A and 11B illustrate simulation results of a differential phase image in the x direction and in the y direction obtained by the present reference example. In FIGS. 11A and 11B, non-uniform distribution is caused on the background of the differential phase image. FIG. 11C illustrates a phase image acquired by integrating data of the differential phase image of FIGS. 11A and 11B. Compared with FIG. 4D that is a theoretical phase image, the phase information of the object illustrated in FIG. 11C is distorted and the accuracy is low.

In the present reference example, by using the reference data, the phase information on the object can be acquired, in which non-uniformity of the interferometer caused by distortion within a surface including the diffraction grating and the shield grating, unevenness of radiation of X-ray, and the like has been corrected. However, the present reference example does not consider the above-described non-uniformity of the interferometer being changed between a case where the reference data is detected and a case where the object data is detected. Therefore, it is considered that non-uniform distribution is caused in the background, or the phase information is distorted as illustrated in FIGS. 11A to 11C.

### Reference Example 2

In Reference example 2, the method disclosed in the above-described Japanese Patent No. 4583619 (corresponding U.S. Pat. No. 6,532,073) is applied to a Fourier transform method and a relative phase value of an object is acquired, and a phase image is acquired. As object data, the moiré illustrated in FIG. 5 is used, similarly to Reference example 1.

First, a difference between the reference data (first detection result) and the object data (second detection result) is obtained, and the obtained relative intensity distribution is subjected to Fourier transform, and a space frequency spectrum is acquired. Hereinafter, the space frequency spectrum obtained by the Fourier transform on the relative intensity distribution may sometimes be referred to as a relative space frequency spectrum. A complex amplitude of the relative space frequency spectrum is obtained and a value of a displacement error of a phase shift device is acquired. This value of a displacement error is an average value of changes caused in overall data when the reference data and the object data are compared. This value of a displacement error is used for correction in acquiring a phase image from the differential phase image illustrated in FIGS. 11A and 11B. A result thereof is illustrated in FIG. 11D. Compared with the phase image (FIG. 11C) obtained in Reference example 1, the overall inclination error of the phase can be corrected.

This is because the overall change of the interferometer caused by displacement of relative position, relative inclination, and relative rotation angle of the interference pattern and the shield grating can be corrected by using the value of a displacement error for correction.

### Exemplary Embodiment 1

In Exemplary embodiment 1, a method of acquiring information on distribution of changes of an interferometer related to an exemplary embodiment of the embodiment will be described. In the present exemplary embodiment, the information on distribution of changes of an interferometer is acquired using window Fourier transform, and a differential phase image and a phase image are acquired using that information.

The window Fourier transform is a technology in which a part of an image is removed using a window function in advance before the image is subjected to Fourier transform, and only the removed area is subjected to Fourier transform, so that only local information is extracted. Note that performing of the window Fourier transform on an image like this means that the Fourier transform is performed after the window function is multiplied by the image. Therefore, performing of the window Fourier transform on an image is included in the Fourier transform. The window Fourier transform is defined by the following formula:

Sf(x,y,kₓ,k_{y})=∫f(x′,y′)g(x′−x,y′−y)e^{-ix′k}^{ₓ}^{-iy′k}^{_{y}}dx′dy′ (Formula 1)

Here, (x, y) represents coordinates, (k_{y}, k_{y}) represents a wave number, f(x, y) represents an original function, and g(x, y) represents a window function.

To acquire a value of a change of the interferometer caused between when reference data (first detection result) is detected and when object data (second detection result) illustrated in FIG. 5 is detected as distribution, the reference data may be subtracted from the object data and relative intensity distribution is acquired, and the relative intensity distribution may just be subjected to the window Fourier transform. That is, as an original function f(x, y) of Formula 1, the relative intensity distribution is used. Where the wave number (kₓ, k_{y}) is a carrier frequency (ωₓ, ω_{y}) of a moiré, and the distribution of changes of the interferometer is R(x, y), distribution R (x, y) of changes of the interferometer can be obtained with the following formula:

R(x,y)=Arg└Sf(x,y,ωₓ,ω_{y})┘ (Formula 2)

Here, Arg represents acquiring of a deflection angle of a complex number. That is, the distribution R(x, y) of changes of the interferometer is distribution obtained by performing the window Fourier transform on the relative intensity distribution, acquiring the deflection angle and acquiring a relative phase value, several times. When the window Fourier transform is performed, influence on the deflection angle by the higher component due to the influence of the window function is barely low. Therefore, the deflection angle is hardly influenced by the existence of the object. Therefore, distribution of the deflection angle can be considered as distribution of an amount of change of the interferometer caused between when the reference data is detected and when the object data is detected. However, in a wave number space obtained by performing the window Fourier transform, the larger the size of the window function is, the more the deflection angle is susceptible to the higher component. Meanwhile, the smaller the size of the window function, the less the deflection angle is susceptible to the higher component. However, the information of a change of the interferometer is more unexpectedly dropped. Therefore, the size of the window function is set according to changes caused in an object to be observed of the object and the interferometer. By using the distribution of changes of the interferometer acquired in this way for correction, phase information of the object can be acquired, in which the influence due to the changes of the interferometer caused between when the reference data is detected and when the object data is detected is reduced. Note that, in the present exemplary embodiment, a Gaussian window is used as the window function. To suppress the influence on the deflection angle by the higher component and to effectively acquire the information of a change caused in the interferometer, the size of deviation σ is desirably about several tens of pixels with respect to an image having several hundreds of pixels in length and width when using the Gaussian window. More favorably, σ is about n/10 to n/3 with respect to the pixel number n in length and width of an image. Here, 64 pixels are set to the deviation a, which are about n/4 of an image of 508 pixels in length and width.

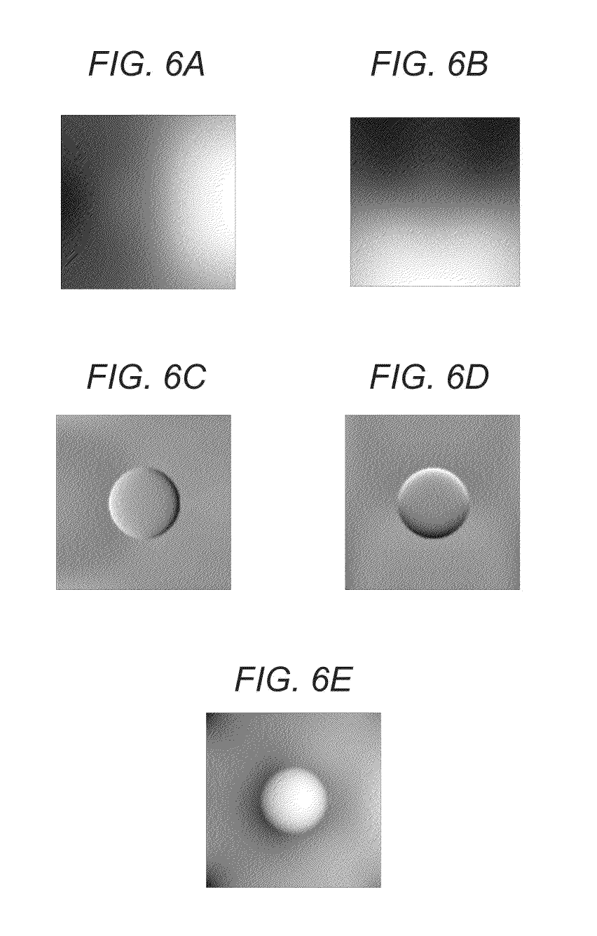

Simulation results of the relative phase distribution calculated by the exemplary embodiment are illustrated in FIGS. 6A and 6B. FIGS. 6A and 6B illustrate distribution of changes of the interferometer in the x direction (lateral direction in the drawing) and in the y direction (longitudinal direction in the drawing) respectively obtained by the exemplary embodiment. A method of acquiring phase information of the object by using information on the distribution of changes of the interferometer for correction will be described. First, a Fourier transform method is performed using the reference data and the object data by the method described in Reference example 1, and a differential phase is obtained. The differential phase image obtained here is the same as the differential phase image (FIGS. 11A and 11B) obtained in Reference example 1, and is a provisional differential phase image as a type of provisional information. Next, a corrected differential phase image is acquired using the distribution of changes of the interferometer in the x direction illustrated in FIG. 6A for the differential phase in the x direction, and the distribution of changes of the interferometer in the y direction illustrated in FIG. 6B for the differential phase in the y direction. FIG. 6C illustrates a corrected differential phase image in the x direction acquired by obtaining a difference between the provisional differential phase image in the x direction illustrated in FIG. 11A and the distribution of changes of the interferometer in the x direction illustrated in FIG. 6A. Similarly, FIG. 6D illustrates a corrected differential phase image in the y direction acquired by obtaining a difference between the provisional differential phase image in the y direction illustrated in FIG. 11B and the distribution of changes of the interferometer in the y direction illustrated in FIG. 6B. Since the differential phase image after correction is closer to FIGS. 4B and 4C, which are the theoretical differential phase images, than the provisional differential phase image before correction, the accuracy of the differential phase image can be improved by the correction using the information on the distribution of changes of the interferometer. Also, a phase image acquired by integrating the information on the corrected differential phase image in the x direction and in the y direction illustrated in FIGS. 6C and 6D is illustrated in FIG. 6E. Since the phase image is closer to FIG. 4D, which is the theoretical phase image, than the phase image obtained in Reference examples 1 and 2, the accuracy of the phase image corrected by the information on the distribution of changes of the interferometer is improved.

Note that, in the exemplary embodiment, the information on the distribution of changes of the interferometer is acquired by performing the window Fourier transform on the information on the relative intensity distribution that is a difference between the reference data and the object data, and acquiring the deflection angle. However, after the reference data and the object data are respectively subjected to the window Fourier transform, the information of distribution of changes of the interferometer may be acquired. For example, the reference data (first intensity distribution) is subjected to the window Fourier transform and the deflection angle is acquired, and the first phase distribution is acquired, and similarly, the object data (second intensity distribution) is subjected to the window Fourier transform and the deflection angle is acquired, and the second phase distribution is acquired. Then, the distribution of changes of the interferometer may be acquired by obtaining a difference between the first phase distribution and the second phase distribution.

### Exemplary Embodiment 2

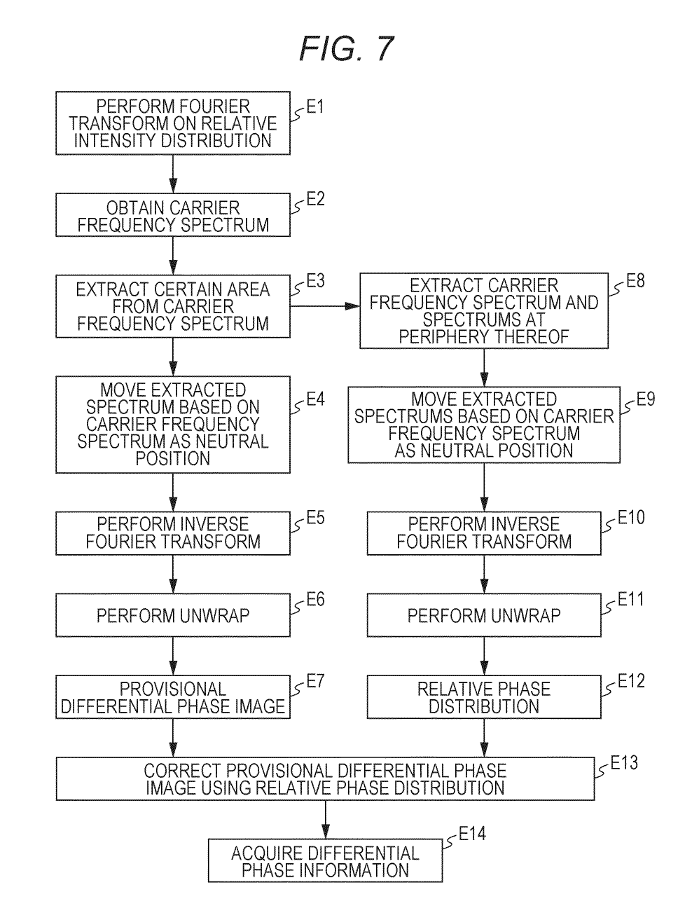

In Exemplary embodiment 2, a method of acquiring information on distribution of changes of an interferometer that is different from the method of Exemplary embodiment 1 will be described. In the present exemplary embodiment, in a procedure of a Fourier transform method, information on distribution of changes of an interferometer is acquired. FIG. 7 illustrates a flowchart of acquiring information (phase information) on a differential phase image in the present exemplary embodiment.

A method of acquiring information on a provisional differential phase image is similar to the above-described phase recovery method by the Fourier transform method. That is, information on relative intensity distribution is subjected to Fourier transform (E1) and a carrier frequency peak in a wave number space is obtained (E2). To acquire a provisional differential phase image by the Fourier transform method, a certain area from the carrier frequency spectrum is extracted (E3), and the extracted carrier frequency spectrum is moved to a neutral position (E4) and is subjected to inverse Fourier transform (E5). Next, unwrap is performed (E6), and information on the provisional differential phase image is acquired (E7). In the present exemplary embodiment, to obtain information on distribution of changes of an interferometer, the carrier spectrum and a spectrum in a narrow area around the carrier spectrum are extracted from the area extracted in E3 (E8). The extracted spectrums here are moved to the neutral position (E9), and inverse Fourier transform is performed (E10), whereby the information on the distribution of changes of the interferometer is extracted.

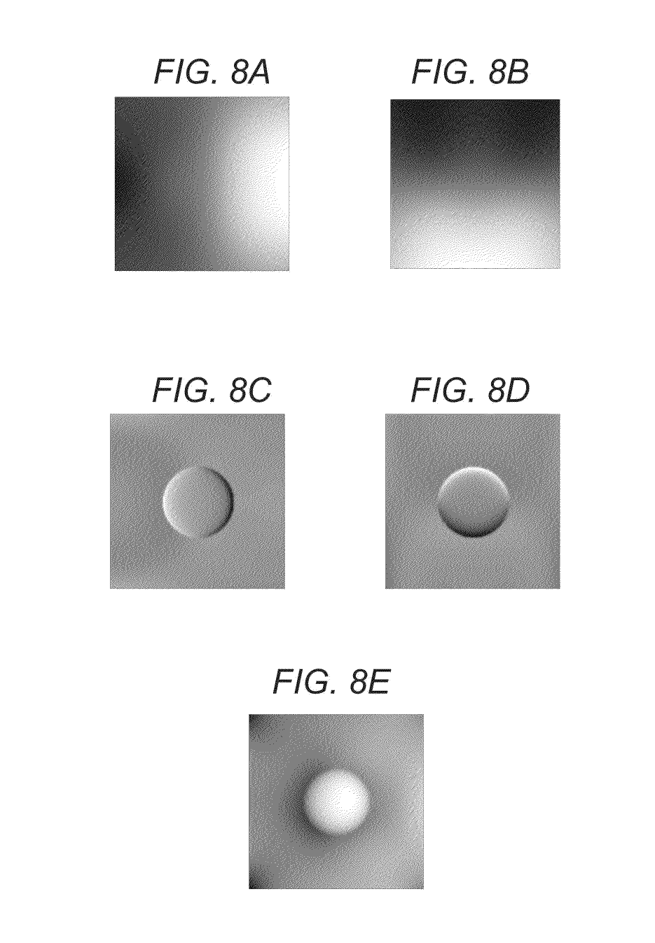

The carrier spectrum and the spectrum in the vicinity thereof include a lower component. As described above, in a space frequency spectrum, changes of the interferometer tend to appear as a lower component than changes of the object. Therefore, the information on the distribution of changes of the interferometer can be acquired from the carrier spectrum and the spectrum in the narrow area in the vicinity of the carrier spectrum. The narrower the area from which the spectrum is extracted in E8, only the lower component can be extracted. Therefore, the information on changes of the object is unlikely to be included. However, the information on the changes of the interferometer is more unexpectedly dropped. In contrast, the wider the area from which the spectrum is extracted in E8, the information on the changes of the interferometer is less unexpectedly dropped. However, the information on the changes of the object is more likely to be included. Therefore, it is desirable to set the width of the area, from which the spectrum is extracted in E8 in the present exemplary embodiment, to be smaller than 1/10 but larger than 1/30 of the width of the area extracted to acquire the provisional information in E3. The width here refers to a width in a frequency axis in the wave number space. To be specific, the area about 2 to 10 pixels from the center of the carrier spectrum is desirable. Here, the area of 4 pixels is extracted, and the information on the distribution of changes of the interferometer is obtained. The results thereof are illustrated in FIGS. 8A and 8B.

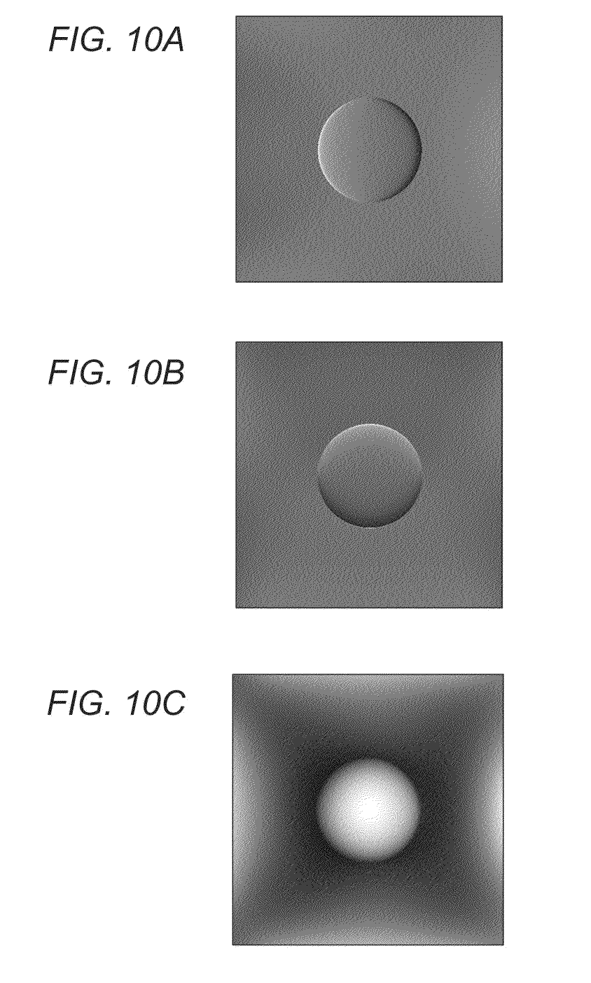

FIG. 8A illustrates the distribution of changes of the interferometer in the x direction, and FIG. 8B illustrates the distribution of changes of the interferometer in the y direction. FIG. 8C illustrates a corrected differential phase image in the x direction acquired by obtaining a difference between the provisional differential phase image in the x direction illustrated in FIG. 11A and the distribution of changes of the interferometer in the x direction illustrated in FIG. 8A. Similarly, FIG. 8D illustrates a corrected differential phase image in the y direction acquired by obtaining a difference between the provisional differential phase image in the y direction illustrated in FIG. 10B and the distribution of the change of the interferometer in the y direction illustrated in FIG. 8B. Since the corrected differential phase image is closer to the FIGS. 4B and 4C, which are the theoretical differential phase images, than the provisional differential phase image before correction, the accuracy of the differential phase image is improved by the correction using the information on the distribution of changes of the interferometer acquired in the present exemplary embodiment. Also, a phase image acquired by integrating the information on the corrected differential phase image in the x direction and in the y direction illustrated in FIGS. 8C and 8D is illustrated in FIG. 8E. Compared with the phase image obtained in Reference examples 1 and 2, the phase image in FIG. 8E is closer to FIG. 4D, which is the theoretical phase image. Therefore, the accuracy of the phase image is improved by the correction using the information on the distribution of changes of the interferometer.

Note that, in the present exemplary embodiment, the information on the distribution of changes of the interferometer is acquired using the information on the relative intensity distribution. However, the information on the distribution of changes of the interferometer may be acquired after the reference data and the object data are respectively subjected to the Fourier transform. For example, the reference data (first intensity distribution) is subjected to the Fourier transform, a carrier spectrum and a spectrum in the vicinity thereof are extracted, and a first phase distribution is acquired. Similarly, the object data (second intensity distribution) is subjected to the Fourier transform, a carrier spectrum and a spectrum in the vicinity thereof are extracted, and a second phase distribution is acquired. Then, by obtaining a difference between the first phase distribution and the second phase distribution, the information on the distribution of changes of the interferometer may be acquired.

Although, in Exemplary embodiments 1 and 2, the provisional differential phase image is corrected using the information on the distribution of changes of the interferometer, a direct feedback may be given to the apparatus based on the information on the distribution of changes of the interferometer. In this manner, accumulation of change over time can be reset. Therefore, an amount of change of the interferometer when intensity distribution is detected next time can be reduced.

### Exemplary Embodiment 3

In Exemplary embodiment 3, as a modification of Exemplary embodiment 2, a method of acquiring directly corrected phase information on an object by performing phase recovery while removing an area that includes information on distribution of changes of an interferometer without acquiring the information of distribution of changes of an interferometer or provisional information will be described.

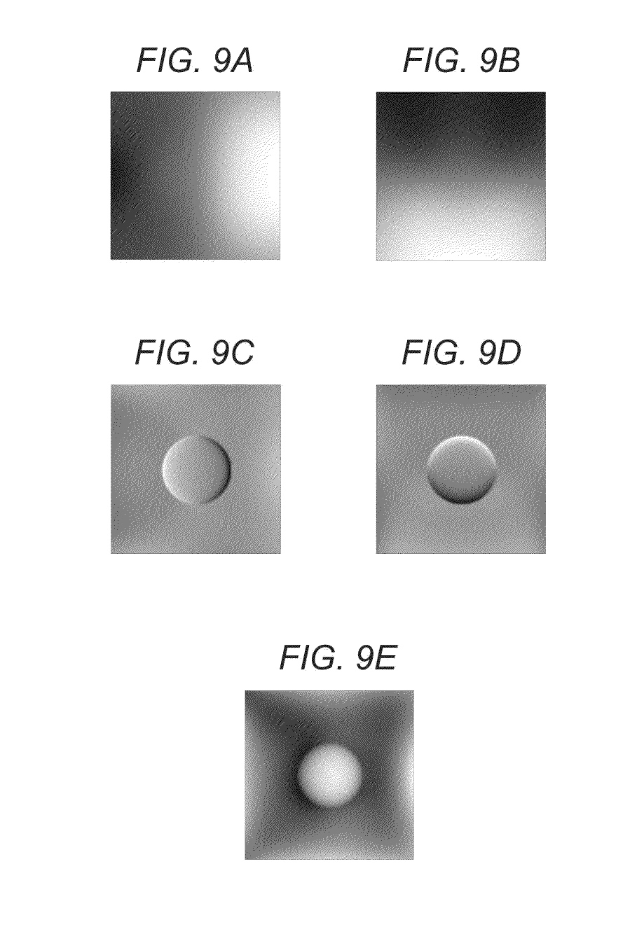

First, similarly to Exemplary embodiment 2, relative intensity distribution is subjected to Fourier transform and a space spectrum is acquired. Next, by removing a carrier spectrum and a spectrum in the vicinity thereof from the acquired space spectrum (the spectrum removed in E8 in Exemplary embodiment 2), a space spectrum from which a lower component is removed is acquired. A certain area from the carrier spectrum is extracted and moved to a neutral position and is subjected to inverse Fourier transform, using the space spectrum from which the lower component has been removed, similarly to a typical Fourier transform method, so that information of corrected differential phase image can be acquired. Also, when the removed spectrum is subjected to inverse Fourier transform, relative intensity distribution can be acquired. Here, it is desirable that an area of the removed spectrum be about 3 to 10 pixels. Here, simulation results in which the spectrum of 2 pixels is removed and the relative intensity distribution is acquired are illustrated in FIGS. 9A and 9B.

FIGS. 9A and 9B respectively illustrate relative phase distributions in the x direction (lateral direction in the drawing) and in the y direction (longitudinal direction in the drawing) acquired in the exemplary embodiment.

Also, FIGS. 9C and 9D respectively illustrate corrected differential phase images in the x direction and in the y direction acquired in the present exemplary embodiment. Also, FIG. 9E illustrates a phase image acquired by integrating the differential phase images illustrated in FIGS. 9C and 9D. Similarly to Exemplary embodiments 1 and 2, an image closer to the theoretical differential phase image and the phase image than Reference examples 1 and 2 can be obtained.

Note that, when the space spectrum from which the lower component has been removed is subjected to inverse Fourier transform as it is (without removing a certain area from the carrier spectrum and moving it to the neutral position), relative intensity distribution from which the lower component has been removed can be obtained.

### Exemplary Embodiment 4

The above reference examples and exemplary embodiments acquire the information on the object using the Fourier transform method. However, these techniques can be similarly applied to the phase shift method. In the phase shift method, a plurality of moiré images is acquired by detecting an X-ray while changing a relative position between an interference pattern and a shield grating, and a phase is recovered from information on a plurality of detection results thereof. However, during the detection, a change of an interferometer (a change other than a change of the relative position between the interference pattern and the shield grating, and an error of the relative position change) may be caused. This change of the interferometer influences the information on the object obtained from the information on the detection results. Therefore, in the exemplary embodiment, a method will be described, in which distribution of changes of the interferometer is used for correction of the change of the interferometer caused among the plurality of detection results when the phase shift method is used.

Moirés used in the phase shift method are roughly classified into two categories. The first category refers to one that includes a fringe having a short cycle, similar to the Fourier transform method, like Japanese Patent No. 4583619 (corresponding U.S. Pat. No. 6,532,073), and the second category refers to one that includes a fringe having a long cycle (including cycle infinity). Note that, in the present exemplary embodiment, a moiré refers to intensity distribution itself formed on a detection surface with an interference pattern and a shield grating, and a fringe refers to cyclic intensity distribution included in the moiré. Information on a differential phase image can be corrected by obtaining change distribution of the interferometer, regardless of the cycle of the fringe. With this correction, the quantitativeness of the information on the differential phase image of an object can be enhanced.

A case of using the moiré having a short-cycle fringe will be described.

Here, the short-cycle fringe refers to a fringe having a cycle shorter than n/32 with respect to the pixel number n in length and width of an image. When the cycle of the fringe to be used in the phase shift method is smaller than n/32, first, information on a wave number space spectrum is acquired by the Fourier transform, similarly to the case of Exemplary embodiment 2.

Then, a narrow area in the vicinity of a carrier spectrum is removed from the wave number space spectrum. Consequently, information on distribution of changes of an interferometer included in the narrow area in the vicinity of the carrier spectrum can be removed. The wave number space spectrum from which the narrow area has been removed is subjected to inverse Fourier transform, so that a corrected moiré is obtained. The width of the removed area is desirably smaller than 1/10 but larger than 1/30 of the distance between the center of the carrier spectrum and the neutral position on the wave number space.

This processing is performed on information on all detection results, and information on a plurality of corrected moirés is acquired. Then, information on an object is acquired from the acquired information on the plurality of corrected moirés. This method is different from past phase shift methods in that the corrected moiré is obtained by removing the narrow area in the vicinity of the carrier spectrum. However, this method and the past phase shift methods are in common in that the information on the object is acquired by recovering the phase using a plurality of moirés. That is, in acquiring the information on the object from the information on the corrected moiré, various types of algorithm used in the phase shift methods can be used.

A case of using a moiré having a long-cycle fringe will be described.

Here, the long-cycle fringe refers to a fringe having a cycle longer than n/32 with respect to the pixel number n in length and width of an image. In the case where the cycle of the fringe to be used in the phase shift method is longer than n/32, even if the information on the wave number space spectrum is acquired by the Fourier transform like the above, the distance between the carrier frequency spectrum and the neutral position in the wave number space is short. Therefore, removal of the area having the distribution of changes of the interferometer (an area having information on a lower component) is difficult. In this case, the phase recovery by a phase shift is performed and a provisional differential phase image is obtained, and this image is subjected to the Fourier transform, so that a frequency spectrum of the provisional differential phase image is acquired. In the wave number space spectrum, the carrier frequency spectrum has a peak at the neutral position in the wave number space. Therefore, the information on the distribution of changes of the interferometer can be removed by removing an area at a certain distance from the spectrum (that is, an area at a certain distance from the neutral position). Note that the width of the area to be removed is favorably n/10 or more and n/3 or less of the pixel number n in length and width of an image. The wave number space spectrum, from which the area at a certain distance from the peak appearing on the neutral position has been removed, is subjected to the inverse Fourier transform, so that information in which the information on the provisional differential phase image has been corrected, that is, the information on the differential phase image can be acquired. Note that this method can be used not only in the case where the phase shift method is performed using a moiré having a long cycle fringe, but also in a case where the phase shift method is performed using a moiré having a short cycle fringe. Also, this method can be used in a case where the provisional differential phase image is obtained using a Fourier transform method. That is, information on the provisional differential phase image obtained using the Fourier transform is again subjected to the Fourier transform, and a certain area from the neutral position of the obtained wave number space spectrum is removed and is subjected to the inverse Fourier transform, so that a differential phase image can be obtained.

FIG. 10C illustrates a simulation result where the information on the phase image of the object is acquired by the method in the exemplary embodiment by using the differential phase image illustrated in FIGS. 10A and 10B as the provisional differential phase image. Note that FIG. 10A illustrates the differential phase image obtained by differentiating in the lateral direction in the drawing, and FIG. 10B illustrates the differential phase image obtained by differentiating in the longitudinal direction in the drawing. FIGS. 10A and 10B illustrate the differential phase images acquired using infinite-cycle moirés. Therefore, among the above-described two methods, a method used for a long-cycle moiré is used and the information on the phase image of the object is calculated. That is, information on each of FIGS. 10A and 10B is subjected to the Fourier transform, and two wave number space spectrums are acquired. In the acquired two wave number space spectrums, information on certain areas from the neutral positions, and these frequency spectrums are subjected to the inverse Fourier transform, so that information on two corrected differential phase images (not illustrated) is acquired. Further, the information on the obtained two corrected differential phase image is integrated, and information on the phase image (FIG. 10C) of the object is acquired. An obtained phase image of the object by integrating the information on the differential phase images illustrated in FIGS. 10A and 10B are illustrated in FIG. 12.

Table 1 illustrates errors between the information on the phase image acquired in Reference examples 1, 2, the past example in the phase shift method (referred to as Reference example 3), and in Exemplary embodiments 1, 2, 3, and 4, and the information on the theoretical phase image (the image illustrated in FIG. 4D) in deviation. The errors between values that constitute the phase image and values of the information on the theoretical phase image are respectively calculated, and are illustrated in deviation. The smaller the numerical values, the recovered phase is more accurate.

TABLE 1

| | |
|---|---|
| Reference example 1 | 118.72 |
| Reference example 2 | 23.86 |
| Reference example 3 | 188.82 |
| Exemplary embodiment 1 | 4.59 |
| Exemplary embodiment 2 | 6.68 |
| Exemplary embodiment 3 | 6.69 |
| Exemplary embodiment 4 | 6.78 |

It can be seen from Table 1 that a more accurate phase image can be acquired by using Exemplary embodiments 1, 2, 3, and 4 than Reference examples.

Note that, in Exemplary embodiments 1, 2, 3, and 4, the two-dimensional Talbot interferometer is used. However, as the interferometer, a one-dimensional Talbot interferometer that forms a one-dimensional moiré can be used. Also, other interferometers that form a one-dimensional or two-dimensional interference pattern (including a moiré) are similarly applicable. In a case where an interferometer, which is not a differential interferometer, is applied, the distribution of changes of the interferometer acquired by the above-described method is the distribution of an amount of change of a phase by the interferometer. Therefore, the distribution is used for correction of the information on a phase image.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-121245, filed May 28, 2012, and Japanese Patent Application No. 2013-097079, filed May 2, 2013, the disclosure of these applications is hereby incorporated by reference herein in its entirety.

What is claimed is:

1. An apparatus for acquiring information of an object comprising:
an interferometer including an optical device configured to form an interference pattern by light entering from a light source, and a detector configured to detect the interference pattern; and
an arithmetic unit configured to acquire information related to a phase of the object using a first detection result and a second detection result detected by the detector,
wherein the arithmetic unit acquires the information related to the phase of the object using information on a distribution of changes of the interferometer acquired from the first detection result and the second detection result.

2. The apparatus for acquiring information of an object according to claim 1, wherein the information on distribution of changes of the interferometer is information on distribution of a low frequency component among differences between the first detection result and the second detection result.

3. The apparatus for acquiring information of an object according to claim 1, wherein the information on distribution of changes of the interferometer is
acquired using a Fourier transform, and
used for correcting the acquired information related to a phase of the object.

4. The apparatus for acquiring information of an object according to claim 1, wherein the arithmetic unit performs window Fourier transform on each of the first detection result and the second detection result, or on information on relative intensity distribution that is a difference between the first detection result and the second detection result, and
acquires a deflection angle, more than once, to acquire the information on distribution of changes of the interferometer.

5. The apparatus for acquiring information of an object according to claim 1, wherein the arithmetic unit
acquires a space frequency spectrum by performing Fourier transform on each of the first detection result and the second detection result, or on information on relative intensity distribution that is a difference between the first detection result and the second detection result,
extracts an area around a carrier frequency from the space frequency spectrum and acquires provisional information related to the phase of the object, and
extracts an area around the carrier frequency and narrower than the area extracted in acquiring the provisional information related to the phase of the object, and acquires the information on distribution of changes of the interferometer, and acquires information related to the phase on the object by correcting the provisional information related to the phase of the object using the information on distribution of changes of the interference pattern.

6. The apparatus for acquiring information of an object according to claim 5, wherein the information on distribution of changes of the interferometer is acquired using an area having a width larger than 1/30 but smaller than 1/10 of a width of the area extracted in acquiring the provisional information related to a phase of the object.

7. The apparatus for acquiring information of an object according to claim 1, wherein the arithmetic unit
acquires information on first phase distribution from the first detection result and information on second phase distribution from the second detection result, respectively, and
acquires information on distribution of changes of the interferometer from the information on first phase distribution and the information on second phase distribution.

8. The apparatus for acquiring information of an object according to claim 7, wherein the information on first phase distribution is information on distribution of a low frequency component included in the first detection result, and
the information on second phase distribution is information on distribution of a low frequency component included in the second detection result.

9. The apparatus for acquiring information of an object according to claim 1, wherein the arithmetic unit acquires information on distribution of changes of the interferometer from information on relative intensity distribution that is a difference between the first detection result and the second detection result.

10. The apparatus for acquiring information of an object according to claim 1, wherein the arithmetic unit
acquires provisional information related to the phase of the object by a phase shift method using the first detection result and the second detection result, and
removes an area at a certain distance from a neutral position in a wave number space spectrum acquired by performing Fourier transform on the provisional information.

11. An apparatus for acquiring information of an object comprising:
an interferometer including an optical device configured to form an interference pattern by light entering from a light source, and a detector configured to detect the interference pattern; and
an arithmetic unit configured to acquire information related to a phase of an object using a first detection result and a second detection result detected by the detector,
wherein the arithmetic unit removes an area having information on distribution of changes in the interferometer among differences between the first detection result and the second detection result, and acquires information related to the phase of the object.

12. The apparatus for acquiring information of an object according to claim 11, wherein the arithmetic unit
acquires a space frequency spectrum by performing Fourier transform on each of the first detection result and the second detection result, or on relative intensity distribution that is a difference between the first detection result and the second detection result, and
removes information on distribution of changes of the interferometer from among the differences between the first detection result and the second detection result by removing an area having the information on distribution of changes of the interferometer around a carrier frequency from the space frequency spectrum.

13. The apparatus for acquiring information of an object according to claim 11, wherein the area having information on distribution of changes of the interferometer is an area having information on distribution of a low frequency component.

14. The apparatus for acquiring information of an object according to claim 13, wherein the area having the information on distribution of changes of the interferometer is an area of 2 to 10 pixels around the carrier frequency.

15. The apparatus for acquiring information of an object according to claim 12, wherein the arithmetic unit acquires information on the object by performing phase recovery by a phase shift method or by a Fourier transform method using a space frequency spectrum from which the area having the information on distribution of changes of the interferometer has been removed.

16. The apparatus for acquiring information of an object according to claim 1, wherein the information related to a phase of the object is at least one of a differential phase image and a phase image of the object.

17. The apparatus for acquiring information of an object according to claim 1, wherein the arithmetic unit acquires the information related to a phase from three or more detection results detected by the detector.

18. The apparatus for acquiring information of an object according to claim 1, wherein the interferometer is a differential interferometer.

19. A program configured to acquire information related to a phase of an object from a first detection result and a second detection result detected by a detector provided in an interferometer, the program
acquiring information on distribution of changes of the interferometer from the first detection result and the second detection result, and
acquiring information related to the phase of the object using the information on distribution of changes of the interferometer.

20. A program configured to acquire information related to a phase of an object from a first detection result and a second detection result detected by a detector provided in an interferometer,
the program removing an area having information on distribution of changes of the interferometer among differences between the first detection result and the second detection result to acquire information related to a phase of the object.
